(19) United States
(12) Patent Application Publication
(10) Pub. No.: US 2009/0031995 A1
(43) Pub. Date: Feb. 5, 2009

(54) Fuel supply apparatus

(75) Inventor: Mamoru Tateishi, Kariya-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, Obu-shi (JP)

(21) Appl. No.: 12/216,613

(22) Filed: Jul. 8, 2008

(30) Foreign Application Priority Data
Aug. 1, 2007 (JP) 2007-201275

(51) Int. Cl. F02M 37/04

(52) U.S. Cl. 123/509

(57) ABSTRACT

A fuel supply apparatus arranged to control supply of fuel includes a motor-driven fuel pump to be placed in a fuel tank, a mounting plate for closing a mounting hole of the fuel tank, a reserve cup that houses the fuel pump, and a pump controller adapted to control power supply to the fuel pump, and the pump controller is placed below the mounting plate and above the fuel pump.

### BACKGROUND OF THE INVENTION

1. Field of the Invention

The present invention relates to a fuel supply apparatus arranged to control operation of a fuel pump by a pump controller to control fuel supply.

2. Description of Related Art

Heretofore, a fuel supply apparatus integrally including a pump controller for controlling operation of a fuel pump (a controller-integrated fuel supply apparatus) has been known. This type of fuel supply apparatus is arranged such that the number of revolutions of the fuel pump is controlled by the pump controller to change an amount of fuel to be discharged from the fuel pump.

One example of such fuel supply apparatus is disclosed in JP2004-332582A. This fuel supply apparatus is provided with a cover that covers an opening of a fuel tank, a motor-driven fuel pump placed in the fuel tank, a level gauge for detecting a liquid level of fuel in the fuel tank, a level gauge control circuit for processing an output signal of the level gauge, and a pump control circuit for drivingly controlling the fuel pump. The pump control circuit is mounted on the cover and integral with the fuel supply apparatus.

In the conventional fuel supply apparatus, however, the pump control circuit is mounted on the cover (a mounting plate) and the pump control circuit and the fuel pump are connected with wire harness. For ensuring weight reduction of a vehicle and enhancing design freedom for a fuel tank, recently, the fuel tank has increasingly been made as a resin molded component. Accordingly, when the conventional fuel supply apparatus is attached to a resin fuel tank, the fuel tank itself could not shield electrical noise (radio noise) radiated from the fuel pump (motor) placed in the fuel tank and the wire harness. This would cause a problem that the pump control circuit may be adversely affected by the electrical noise. For instance, the pump control circuit may cause malfunction of the fuel pump due to the electrical noise or further amplify the electrical noise that the pump control circuit receives.

Herein, when an electrical filter (a low-pass filter) is added to the pump control circuit, radiation noise from the fuel pump and the wire harness can be reduced. However, such electrical filter provided in the pump control circuit leads to an increase in size of the pump controller. It is therefore difficult to mount the pump controller on the cover. Further, if the pump control circuit itself has a large size even without addition of an electric filter, the pump controller is also hard to mount on the cover. This is because the cover is provided with a fuel pipe and an electrical connector and hence can have only a restricted (small) space for mounting the pump control circuit. If the pump controller is large as above, the pump control circuit could not be integrated with the fuel supply apparatus.

### BRIEF SUMMARY OF THE INVENTION

The present invention has an object to provide a fuel supply apparatus capable of being integrally combined with even a large-sized pump controller and of reducing at least one of electrical noise radiated from a fuel pump and electrical noise radiated between the fuel pump and the pump controller.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

According to the present invention, there is provide a fuel supply apparatus for controlling supply of fuel, comprising: a motor-driven fuel pump to be placed in a fuel tank; a mounting plate for closing a mounting hole of the fuel tank; a reserve cup that houses the fuel pump; and a pump controller adapted to control power supply to the fuel pump; wherein the pump controller is placed below the mounting plate and above the fuel pump.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a side view showing a schematic configuration of a fuel pump unit in a first embodiment;

FIG. 2 is a partly sectional view showing a schematic configuration of inside of a reserve cup and its surroundings;

FIG. 3 is a plan view showing the reserve cup and its surroundings;

FIG. 4 is a plan view showing a schematic configuration of a reserve cup and its surroundings in a fuel pump unit in a second embodiment;

FIG. 5 is a partly sectional view showing a schematic configuration of the reserve cup and its surroundings in the fuel pump unit in the second embodiment; and

FIG. 6 is a side view showing a modified configuration of the fuel pump unit.

### DETAILED DESCRIPTION OF THE PREFERRED EMBODIMENTS

A detailed description of preferred embodiments of a fuel supply apparatus embodying the present invention will now be given referring to the accompanying drawings. In the embodiments, the invention is applied to a fuel pump unit of a vehicle engine.

### Embodiment 1

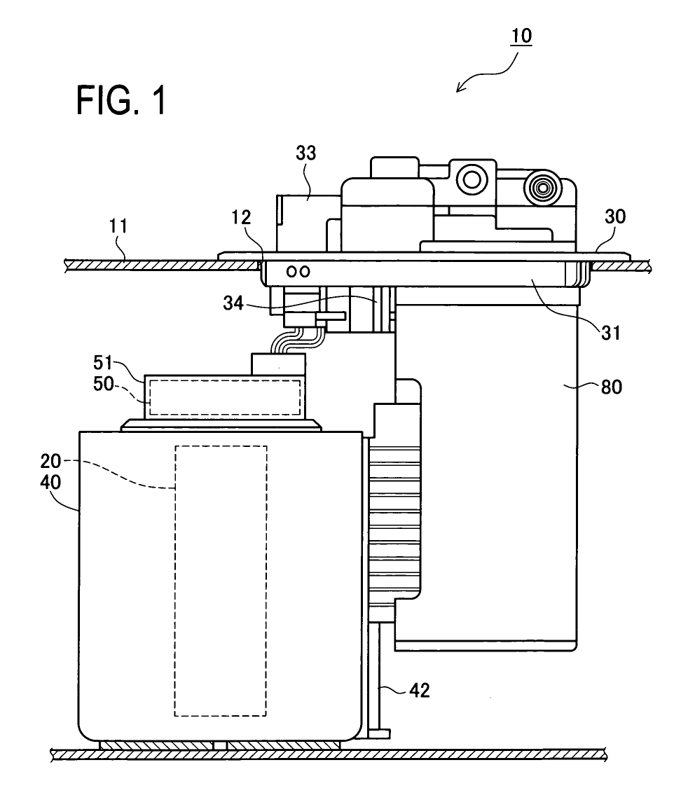

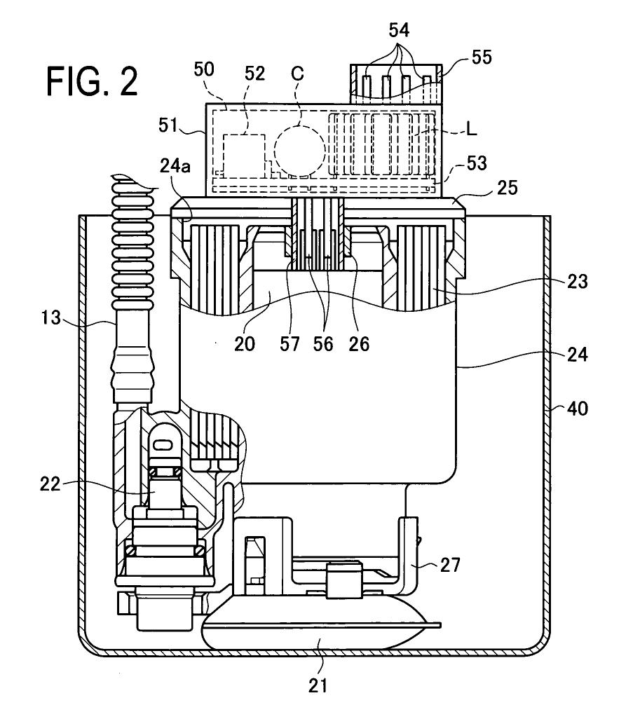

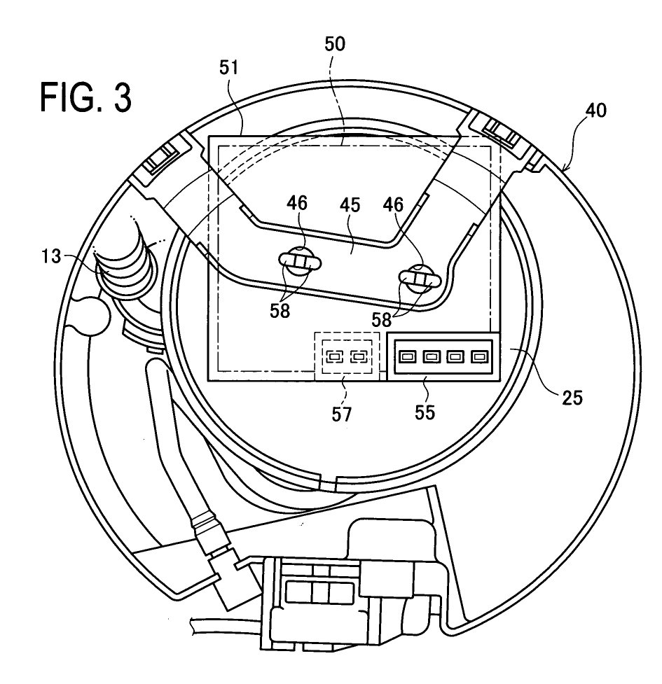

A first embodiment is first explained below. Thus, the following description is given to a fuel pump unit in the first embodiment with reference to FIGS. 1 to 3. FIG. 1 is a side view showing a schematic configuration of the fuel pump unit in the first embodiment. FIG. 2 is a partly sectional view showing a schematic configuration of the inside of a reserve cup and its surroundings. FIG. 3 is a plan view of the reserve cup and its surroundings.

As shown in FIG. 1, a fuel pump unit 10 is a combination of a set plate (a mounting plate) 30 placed to close a mounting hole 12 of a resin fuel tank 11, a reserve cup 40 internally holding a fuel pump 20 and others, and a canister 80. The fuel pump unit 10 is mounted in the fuel tank 11 in such a manner that the set plate 30 is attached to the fuel tank 11 so as to close the mounting hole 12 of the fuel tank 11.

The reserve cup 40 is a resin molded component having a bottom-closed cylindrical shape as shown in FIGS. 2 and 3. In this reserve cup 40, the fuel pump 20, a suction filter 21, a pressure regulator 22, and a fuel filter 23 are set. Those fuel pump 20, suction filter 21, pressure regulator 22, and fuel filter 23 are housed and positioned in place within the reserve cup 40, which are integrated (assembled) together.

The fuel pump 20 has a nearly vertical columnar shape having a bottom provided with a fuel suction pipe (not shown) that is connected to the suction filter 21. The fuel pump 20 is provided, at its upper end, with an electrical connector 26. The fuel pump 20 includes a built-in motor. This motor is energized through the electrical connector 26 to activate the fuel pump 20 to suck the fuel contained in the reserve cup 40 through the suction filter 21 while increasing fuel pressure, and then discharge the fuel through a fuel discharge port (not shown).

The suction filter 21 is made of a bag-shaped nylon filter and a resin framework or skeleton inserted therein. An inner space of the bag-shaped filter communicates with a suction hole of the fuel pump 20. The suction filter 21 is housed in the reserve cup 40 and held sideways on a bottom surface of the reserve cup 40. Foreign matters contained in the fuel are roughly removed through the suction filter 21 and will be further removed later through the fuel filter 23 as mentioned later. Then, the fuel from which most of foreign matters have been removed is sucked in the fuel pump 20.

The fuel pump 20 is placed in the center (a hollow section) of a filter case 24. The fuel filter 23 is of an annular shape and set in the filter case 24 to surround the fuel pump 20. The fuel pump 20 is housed in this filter case 24 so that the periphery of the fuel pump 20 is entirely covered by the filter case 24. The fuel pump 20 is housed in such a manner as to be inserted in the hollow section of the filter case 24 from its bottom opening. The bottom of the filter case 24 is assembled with a stay 27 whereby the fuel pump 20 can be prevented from coming off the filter case 24. A cushion rubber (not shown) is interposed between the fuel pump 20 and the stay 27 to elastically support the fuel pump 20.

An opening 24a of the filter case 24 is closed by a filter cover 25. Those filter case 24 and filter cover 25 are respectively molded of resin. A pump controller 50 is mounted on top of the filter case 24. Specifically, the pump controller 50 is located below the set plate 30 and above the fuel pump 20. In other words, the pump controller 50 is placed on top of the reserve cup 40.

The filter case 24 is internally divided in two chambers; an inner chamber and an outer chamber, by the fuel filter 23. The outer chamber of the filter case 24 communicates with a fuel discharge port of the fuel pump 20. The inner chamber of the filter case 24 communicates with a fuel supply pipe 13 via the pressure regulator 22. Accordingly, the fuel discharged from the fuel pump 20 flows from the outer chamber to the inner chamber of the filter case 24 through the fuel filter 23 and then flows to the fuel supply pipe 13 through the pressure regulator 22.

The pressure regulator 22 is a relief valve for keeping the pressure of fuel discharged from the fuel pump 20 at a predetermined level. The pressure regulator 22 is arranged to control the pressure of fuel to be supplied to the fuel filter 23 and hence the pressure of fuel to be supplied to an engine (not shown) to a predetermined value. Fuel released by the pressure regulator 22 for control of the fuel pressure is returned to the reserve cup 40 through a returning pipe and a jet pump (both not shown).

The fuel supply pipe 13 is placed passing through the set plate 30 to the outside of the fuel tank 11. In this embodiment, the fuel supply pipe 13 is connected to an injector (not shown) through a delivery pipe (not shown) provided in the engine. Accordingly, the fuel will be supplied from the fuel tank 11 to the injector through the fuel pump 20.

On the other hand, the set plate 30 has a nearly circular plate shape. As shown in FIG. 1, the set plate 30 includes an annular guide fitting part 31 protruding downward, a pipe joint (not shown) vertically passing through the set plate 30, and an electrical connector 33 provided with a terminal electrically connected to an input terminal 54 of the pump controller 50. This electrical connector 33 is connected to a battery serving as a vehicle-mounted power source or the like to provide electrical connection between the vehicle-mounted power source and the pump controller 50. The set plate 30 is a resin molded component.

The guide fitting part 31 of the set plate 30 is provided with a guide rod 34 extending downward, which corresponds to a cylindrical guide part 42 of the reserve cup 40. The guide rod 34 is slidably inserted in the cylindrical guide part 42 of the reserve cup 40. The guide rod 34 is fitted thereon with a coil spring (not shown). This coil spring is placed between the guide fitting part 31 and the cylindrical guide part 42, thereby continuously urging the reserve cup 40 downward. Since the fuel tank 11 is made of resin by blow molding, it may slightly be deformed depending on a remaining fuel amount and a temperature change. The reserve cup 40 is always urged into contact with the bottom wall of the fuel tank 11 against deformation of the fuel tank 11.

The canister 80 is incorporated in the set plate 30 as shown in FIG. 1. Concretely, a housing of the canister 80 (also referred to as a canister housing) is integrally formed with the set plate 30 and has a bottom-closed nearly semi-cylindrical shape. The set plate 30 is also used as a mounting part for setting the canister 80 in the fuel tank 11.

Herein, the pump controller 50 for controlling the fuel pump 20 is housed in a controller case 51. The controller case 51 is a fully hermetically-sealed case, which is made of an electrically conductive material. In this embodiment, the controller case 51 is made of metal. Besides being made of metal, the controller case 51 may also be made of an electrically conductive resin material, a resin material with a metal net or mesh embedded therein by insert molding, a resin material having a metal-plated surface. The electrically conductive resin material may include a resin material mixed with a metal material such as “SUS filler”. The metal net or mesh may include metal such as “chrome-plated iron or SUS”. The metal plating may be achieved by using metal such as “electroless copper” and “electroless nickel”.

The pump controller 50 is provided, as shown in FIG. 2, with a condenser C, a choke coil L, a drive circuit 52 including a transistor and a diode. Those condenser C, choke coil L, drive circuit 52 are packaged on a printed circuit board 53 and wire-connected with each other by wiring pattern formed on the printed circuit board 53 to constitute the pump controller 50. The condenser C and the choke coil L constitute a low-pass filter (an electrical filter).

Herein, providing such low-pass filter in a pump controller causes an increase in size of the pump controller. Thus, the pump controller would be difficult to mount on a set plate as in the conventional case. This may result in difficulty in integrating the pump controller in the fuel pump unit.

In this embodiment, on the other hand, the pump controller 50 is placed in a large space in the fuel tank 11, the space existing below the set plate 30 and above the fuel pump 20. To be more specific, the pump controller 50 is disposed on top of the reserve cup 40. Accordingly, even the large-sized pump controller 50 having the low-pass filter can be integrated in the fuel pump unit 10.

The controller case 51 is provided, on its upper surface, with an input connector 55 in which input terminals 54 of the pump controller 50 are exposed. Each input terminal 54 is connected to the wiring pattern formed on the printed circuit board 53. The controller case 51 is further provided, on its bottom, with an output connector 57 in which output terminals 56 of the pump controller 50 are exposed. Each output terminal 56 is connected to the drive circuit 52. The output connector 57 is connected to the electrical connector 26 of the fuel pump 20. Further, as shown in FIG. 3, the controller case 51 is formed, on its upper surface, with protrusions 58 for fixing engagement. Each protrusion 58 can be engaged (so-called snap-fit) in an engagement hole 46 of a stay 45.

The controller case 51 is fixedly positioned in place on top of the reserve cup 40 when a lower part, i.e., the output connector 57 is connected with the electrical connector 26 of the fuel pump 20 and an upper part is fixed to the stay 45 securely fitted (snap-fit) in the reserve cup 40. Placing the controller case 51 on top of the reserve cup 40 in this manner can fix the controller case 51 by a simple structure. A large space for placing the pump controller 50 can be ensured.

Operations of the fuel pump unit 10 having the above configuration will be briefly explained below. In the fuel pump unit 10, when the fuel pump 20 is activated, the fuel contained in the reserve cup 40 is sucked in the fuel pump 20 through the suction filter 21. The fuel sucked in the fuel pump 20 is pressurized in a passage groove by rotation of an impeller in the fuel pump 20 and then discharged through a discharge port. The fuel discharged from the fuel pump 20 through the discharge port is allowed to flow in the fuel filter 23, whereby foreign matters are removed from the fuel. The fuel passing through the fuel filter 23 is controlled to a predetermined pressure by the pressure regulator 22 and delivered to the injector through the fuel supply pipe 13 and the delivery pipe.

At that time, the pump controller 50 activates the transistor in the drive circuit 52 based on a control signal from an ECU (an engine controller). By a switching operation of this transistor, voltage to be applied to the fuel pump 20 is turned on/off to vary like pulses. Pulse width and others are controlled based on the control signal from the ECU, controlling an average voltage to be applied to the fuel pump 20 to adjust the number of revolutions of the fuel pump 20.

The pump controller 50 operates the transistor in the drive circuit 52 to execute PWM control. In association with the switching operation of the transistor, accordingly, electric current including much electrical noise flows in wiring in the pump controller 50. However, the low-pass filter constituted by the condenser C and the choke coil L can reduce such electrical noise and also restrain amplification of the electrical noise. Further, transmission of electrical noise from the fuel pump 20 to the drive circuit 52 can also be prevented.

The controller case 51 housing the pump controller 50 is a fully hermetically sealed metal case, so that the controller 50 is electrically shielded. This makes it possible to prevent radiation of electrical noise from the pump controller 50 to the outside. Since the pump controller 50 is placed above the fuel pump 20, furthermore, the pump controller 50 can reduce electrical noise radiated from the fuel pump 20.

The pump controller 50 is located just close by the fuel pump 20, thus needing only short wiring for electrically connecting the fuel pump 20 and the pump controller 50. It is therefore possible to reduce radiation of electrical noise occurring between the fuel pump 20 and the pump controller 50. In this embodiment, particularly, the fuel pump 20 and the pump controller 50 are connector-connected, so that conventionally used wire harness is unneeded for connection between the fuel pump and the pump controller. Thus, electrical noise that would conventionally be radiated from wire harness can be eliminated between the fuel pump 20 and the pump controller 50. As a result, radiation of electrical noise occurring between the fuel pump 20 and the pump controller 50 can greatly be decreased.

Moreover, the controller case 51 housing the pump controller 50 is placed on top of the reserve cup 40. The reserve cup 40 is filled with fuel irrespective of a remaining amount of fuel in the fuel tank 11. Therefore the controller case 51 is allowed to be exposed to the fuel. By this fuel, the controller 50 which is apt to generate heat due to the switching operation of the drive circuit 52 can be cooled. Consequently, there is no need for taking measures to dissipate heat as in the conventional pump controller (e.g., the use of a heat dissipating plate).

According to the fuel pump unit 10 in the first embodiment, as described above, the pump controller 50 is placed below the set plate 30 and above the fuel pump 20, that is, on top of the reserve cup 40. Accordingly, a large space (a space within the fuel tank 11) produced between the fuel pump 20 and the set plate 30 when the fuel pump unit 10 is mounted in the fuel tank 11 can be utilized effectively. In other words, even when the controller 50 has a large size because of addition of the low-pass filter, a sufficient space can be ensured to mount such controller 50. The controller 50 can therefore be integrated in the fuel pump unit 10. Having the low-pass filter, the controller 50 can reduce electrical noise caused by the switching operation of the drive circuit 52 and restrain amplification of the electrical noise. Further, transmittance of the electrical noise from the fuel pump 20 to the drive circuit 52 can also be prevented.

The pump controller 50 can be placed close to the fuel pump 20. This makes it possible to shorten the length of wiring for connection between the pump controller 50 and the fuel pump 20. In the fuel pump unit 10, the pump controller 50 and the fuel pump 20 are electrically connected with each other by direct connection between the connectors 57 and 27, resulting in no need for connection wiring (wire harness). The above configurations can greatly reduce radiation of electrical noise between the pump controller 50 and the fuel pump 20.

Moreover, being located on top of the reserve cup 40, the pump controller 50 can be cooled by the fuel. The pump controller 50 can thus have an improved heat dissipating property, eliminating the necessity of measures to dissipate heat, such as addition of a separate heat dissipating plate.

According to the fuel pump unit 10, the controller 50 is housed in the controller case 51 made of metal. This can keep the controller 50 from being adversely affected by the electrical noise radiated from the fuel pump 20 and also prevent outside leakage of electrical noise occurring in the pump controller 50.

### Embodiment 2

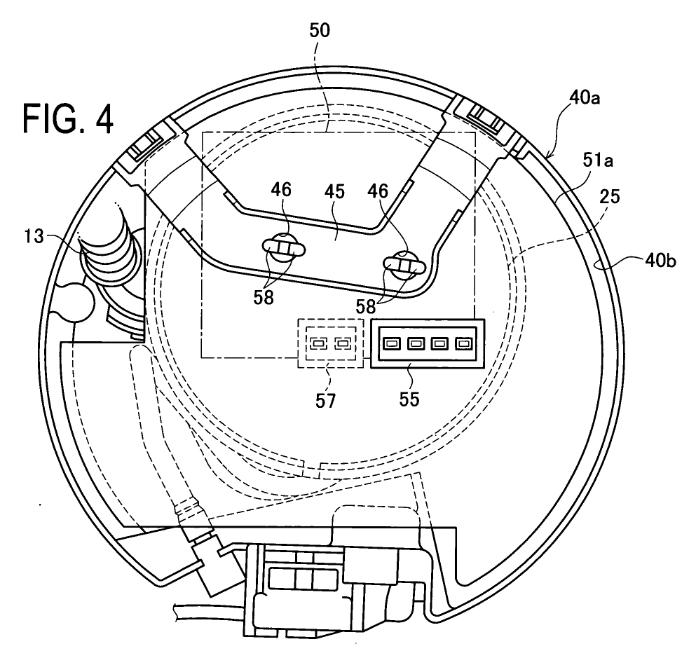

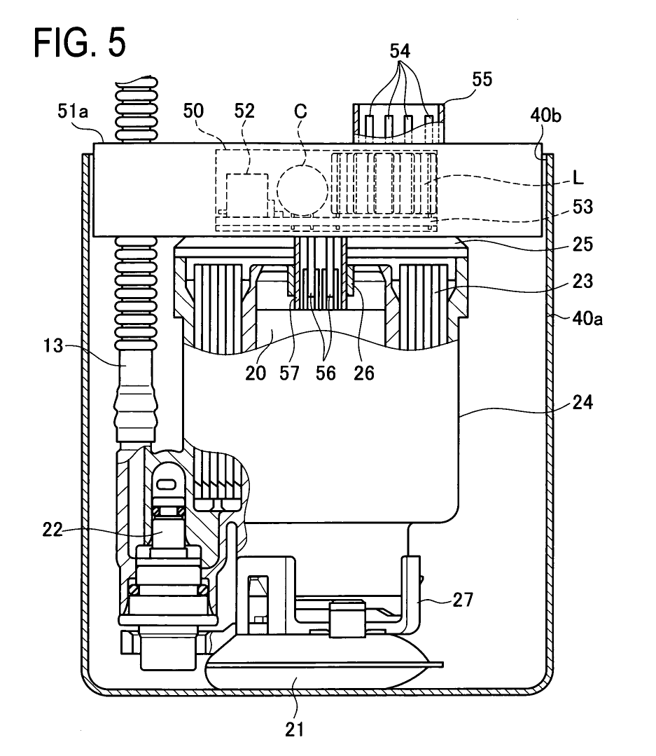

A second embodiment will be explained below. The second embodiment is almost the same in basic configuration as the first embodiment excepting that a controller case is designed to have a size almost equal to an opening of a reserve cup, and the reserve cup (cup height) is designed to be larger in height than that in the first embodiment. In the following description, similar parts or components to in the first embodiment are given the same reference codes and their explanations are omitted, and a fuel pump unit in the second embodiment is explained with a focus on differences from the first embodiment, referring to FIGS. 4 and 5. FIG. 4 is a plan view showing a schematic configuration of the reserve cup and its surroundings in the fuel pump unit in the second embodiment. FIG. 5 is a partly sectional view showing a schematic configuration of the reserve cup and its surroundings in the fuel pump unit in the second embodiment.

In the fuel pump unit in the second embodiment, as shown in FIG. 4, a metal controller case 51a housing the pump controller 50 is almost equal in size (diameter) to an opening 40b of a reserve cup 40a. To be more specific, the controller case 51a is designed to be slightly smaller than the opening 40b of the reserve cup 40a. Accordingly, almost the entire opening plane of the reserve cup 40a can be used as a space for placing the controller 50. That is, a very large space for placing the pump controller can be ensured. Even a controller larger than the controller 50 can therefore be integrally mounted in the fuel pump unit. Since the controller case 51a is slightly smaller than the opening 40b of the reserve cup 40a, the mounting hole 12 formed in the fuel tank 11 does not have to be made larger and also mounting workability will not be deteriorated.

As shown in FIG. 5, the reserve cup 40a is larger in cup height than the reserve cup 40 in the first embodiment. Specifically, an open end of the reserve cup 40a is positioned higher than the position of the filter cover 25. Part of the controller case 51a placed on the filter cover 25 is therefore located inside the reserve cup 40a. In other words, a lower part of the controller case 51a is inserted in the reserve cup 40a. The set plate, which is not shown in FIGS. 4 and 5, and its associated parts or components are the same as those in the first embodiment.

The reserve cup 40a is filled with fuel and hence the controller case 51a is always exposed to the fuel. This can further enhance the effect of cooling the pump controller 50 by the fuel.

The controller case 51a covers the opening 40b of the reserve cup 40a, i.e., serves as a cover of the reserve cup 40a. Accordingly, the controller case 51a can reduce pump noise such as operating noise of the fuel pump 20 and further reduce spilling noise of fuel from the reserve cup 40a when a vehicle is turned around. The controller case 51a can reliably cover over the entire upper part of the fuel pump 20, thereby more reducing the electrical noise radiated from the fuel pump 20.

According to the fuel pump unit in the second embodiment as mentioned above, the controller case 51a housing the pump controller 50 is designed to have a size (diameter) almost equal to the opening 40b of the reserve cup 40a and the lower part of the controller case 51a is located inside the reserve cup 40a designed to be larger in cup height than in the first embodiment. Besides the effects obtained in the first embodiment, therefore, it is further possible to ensure a very large space for placing the controller without widening the mounting hole 12 of the fuel tank 11 and also possible to integrally mount even a controller larger than the controller 50 in the fuel pump unit. Continuously remaining exposed to fuel, the controller case 51a can be cooled by the fuel more effectively. An entire part above the fuel pump 20 can be covered reliably by the controller case 51a and thus electrical noise radiated from the fuel pump 20 can be further reduced. This configuration can also reduce pump noise such as operating noise of the fuel pump 20 and spilling noise of the fuel from the reserve cup 40a during vehicle turning.

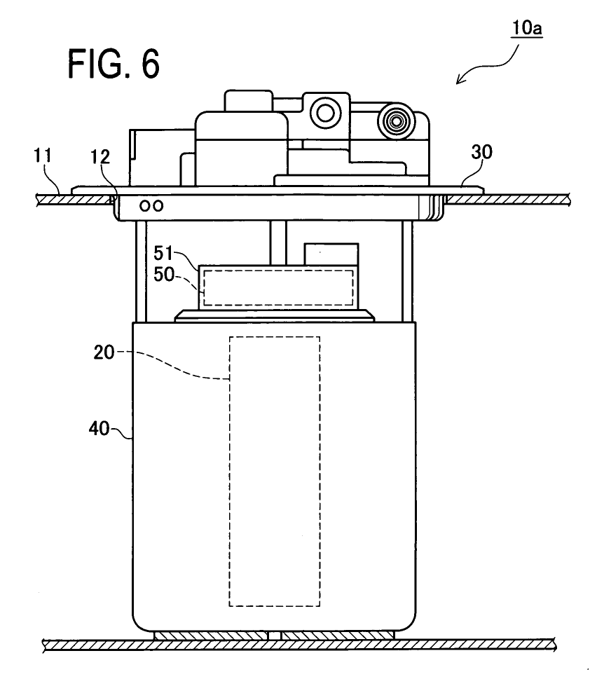

The above embodiments are merely examples and the present invention is not limited to the above embodiment(s) and may be embodied in other specific forms without departing from the essential characteristics thereof. For instance, the above embodiments show the fuel pump unit in which the canister 80 is integrated with the set plate 30. The invention may be applied to a fuel pump unit 10a in which a canister is not integrated with the set plate 30 as shown in FIG. 6. Also in this case, the above effects can be obtained.

In the above embodiments, the circuit of the pump controller 50 is configured on the printed circuit board 53. As an alternative, the circuit may be configured by use of a bus bar without using the printed circuit board (i.e., into a boardless configuration).

The above embodiments are explained by applying the invention to the pump controller 50 provided with the electrical filter. Alternatively, the invention may be applied to a pump controller provided with no electrical filter. For instance, there is a case where electrical noise is less generated from the drive circuit. Particularly, it is more effective for a large-sized drive circuit.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A fuel supply apparatus for controlling supply of fuel, comprising:
a motor-driven fuel pump to be placed in a fuel tank;
a mounting plate for closing a mounting hole of the fuel tank;
a reserve cup that houses the fuel pump; and
a pump controller adapted to control power supply to the fuel pump;
wherein the pump controller is placed below the mounting plate and above the fuel pump.

2. The fuel supply apparatus according to claim 1, wherein
the pump controller is placed on top of the reserve cup.

3. The fuel supply apparatus according to claim 1, wherein
the pump controller includes a drive circuit for drivingly controlling the fuel pump and an electrical filter connected to the drive circuit.

4. The fuel supply apparatus according to claim 2, wherein
the pump controller is housed in a hermetically-sealed case that is placed close to an opening of the reserve cup.

5. The fuel supply apparatus according to claim 4, further comprising a stay formed with a hole and attached to the reserve cup,
wherein the hermetically-sealed case is provided with a protrusion and fixed to the reserve cup while the protrusion is engaged in the engagement hole of the stay.

6. The fuel supply apparatus according to claim 4, wherein
the hermetically-sealed case is almost equal in size to an opening of the reserve cup.

7. The fuel supply apparatus according to claim 6, wherein
the hermetically-sealed case is placed so that a part of the case is located inside the reserve cup.

8. The fuel supply apparatus according to claim 4, wherein
the hermetically-sealed case is made of an electrically conductive material.

9. The fuel supply apparatus according to claim 8, wherein
the electrically conductive material is one of metal, resin mixed with a metal material, resin with a metal mesh embedded by insert molding, and resin having a metal-plated surface.

10. The fuel supply apparatus according to claim 8, wherein
the hermetically-sealed case is provided with a connector that electrically connects between the pump controller and the fuel pump, and
the pump controller includes an output terminal exposed in the connector.
